(19) United States
(12) Patent Application Publication
(10) Pub. No.: US 2009/0245908 A1
(43) Pub. Date: Oct. 1, 2009

(54) Sheet humidification apparatus and image forming system

(75) Inventor: Toshio Shida, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 12/383,155

(22) Filed: Mar. 20, 2009

(30) Foreign Application Priority Data
Mar. 26, 2008 (JP) JP2008-080051

(51) Int. Cl. G03G 15/00

(52) U.S. Cl. 399/407; 399/408

(57) ABSTRACT

A sheet humidification apparatus performs a humidification process on a sheet conveyed from an image forming apparatus in which the sheet is fed from a sheet feeding tray one by one, a toner image is formed on the sheet and the formed toner image is fixed by heat on the sheet, so that the percentage of water content of the sheet does not exceed that of the sheet in the sheet feeding tray.

### BACKGROUND OF THE INVENTION

This application is based on Japanese Patent Application No. 2008-080051 filed on Mar. 26, 2008, in Japanese Patent Office, the entire content of which is hereby incorporated by reference.

### TECHNICAL FIELD

The present invention relates to sheet humidification apparatus to humidify a sheet on which an image having fixed by heat and an image forming system where the humidification apparatus and an image forming apparatus or a bookbinding apparatus are connected.

### BACKGROUND

An image forming apparatus of electrophotographic method forms a tone image on a photoconductive body, transfers the formed toner image onto a sheet, fixes the transferred toner image onto the sheet carrying the toner image by heat, and sends the sheet after the fixing process outside the apparatus.

As mentioned above, since the process of fixing the toner image on the sheet involves heat, curling or undulation occurs on the sheet after the fixing process.

Since curling and undulation generated in the above manner cause a trouble in conveying the sheet in a post-processing apparatus such as bookbinding apparatus in particular, curling and undulation have to be corrected.

To correct curling and undulation generated on the sheet, there is known an image forming apparatus having a device to give moisture to the outputted copied sheet after the fixing process (for example, Patent document 1: Unexamined Japanese Patent Application Publication No. 6-332340).

Also, there is suggested an image forming apparatus to correct curling and undulation of the copied sheet by spraying water droplets in an amount calculated from environmental conditions such as an image, temperature and humidity (for example, Patent Document 2: Unexamined Japanese Patent Application Publication No. 2000-118849).

However, in the above publicly known technologies, it is difficult to find out humidifying conditions to conduct optimum correction and to change the conditions of humidification device to realize the conditions. The conditions includes environmental conditions such as a characteristic of the sheet, a percentage of water content of the sheet before fixing process, a percentage of blackening determined by the image, as well as temperature and humidity.

Patent document 1: Unexamined Japanese Patent Application Publication No. 6-332340

Patent Document 2: Unexamined Japanese Patent Application Publication No. 2000-118849

### SUMMARY OF THE INVENTION

The present invention is realized by the structures below.
Structure 1. A sheet humidification apparatus to performs a humidification process on a sheet conveyed from an image forming apparatus in which the sheet is fed from a sheet feeding tray one by one, a toner image is formed on the sheet and the formed toner image is fixed by heat on the sheet, having a humidification section to perform humidification process so that a percentage of water content of the sheet after humidification do not exceed that of the sheet in the sheet feeding tray.
Structure 2. An image forming system, wherein the sheet humidification apparatus of claim 1 is connected to an electrophotographic image forming apparatus.
Structure 3. The image forming system of structure 2, wherein a bookbinding apparatus to carry out a bookbinding process on the sheet is connected with the sheet humidification apparatus at a downstream side thereof in a sheet conveyance direction.

### BRIEF DESCRIPTION OF THE DRAWINGS

FIG. 1 is a diagram showing an exemplary configuration of an image forming system composed of an image forming apparatus A, a sheet humidification apparatus B and a bookbinding apparatus C.

FIG. 2 is a block diagram showing a control system of the image forming system.

FIGS. 3(a), (b) and (c) are diagrams showing typical examples of undulation and curling.

FIG. 4 is a conceptual diagram of a sheet humidification apparatus.

FIG. 5 is a conceptual diagram of a sheet humidification section.

FIG. 6 is a table showing relations between humidification amounts and humidification effects.

### DESCRIPTION OF THE PREFERRED EMBODIMENT

An exemplary embodiment of the present invention will be described with reference to the drawings.

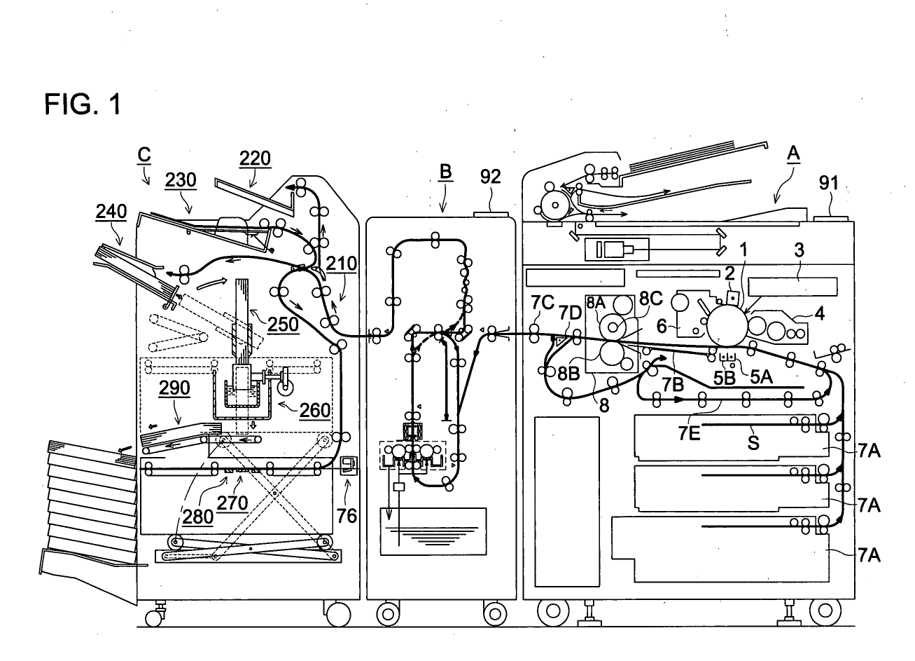

FIG. 1 is a diagram showing an exemplary configuration of an image forming system composed of an image forming apparatus A, a sheet humidification apparatus B and a bookbinding apparatus C.

The image forming apparatus A is provided with an image forming device wherein a charging device 2, an exposing device 3, a developing device 4, a transfer device 5A, a discharging device 5B and a cleaning device 6 at a periphery of an image carrier 1 to rotate.

The image forming device carries out uniform charging on a surface of the image carrier 1 by the charging device 2, forms a latent image on the image carrier 1 by laser beam of the exposing device 3 which carry out exposure by scanning based on image data and develops the latent image by reversal development via the developing device 4 to be a toner image.

The toner image is transferred onto a sheet S fed from a sheet storing section 7A and conveyed to a transfer position. The sheet S carrying the toner image and having been transferred is discharged by the discharging device 5B to be separated from the image carrier 1, and conveyed towards the fixing device 8 via conveyance section 7B.

On the other hand, remaining toner on the surface of the image carrier 1, from which the toner has been transferred onto the sheet S, is removed by the cleaning device 6 to be ready for subsequent image forming.

The fixing device 8 is provide with a heating roller 8A having a heater 8C and a pressure roller 8B in press contact with the heating roller 8A to fix the toner image onto the sheet S by applying pressure and heat onto the sheet S carrying the conveyed toner image.

The sheet S on which the image has been fixed, is sent outside the apparatus via sheet ejection rollers 7E.

In case image forming is carried out for both sides of the sheet S, the sheet S having been fixed by heat through the fixing device 8 is diverged form a normal sheet ejection path via a conveyance path changeover plate 7D, and turned over by switchback through a reversal conveyance section 7E, then conveyed to the image forming device again.

The sheet S having the formed image on the reverse surface thereof, is subject to fixing processing through the fixing device 8 and sent outside the apparatus via sheet ejection rollers 7C.

The sheet S ejected via the sheet ejection rollers 7C is fetched in the sheet humidification apparatus B connect at a downstream side thereof.

The sheet humidification apparatus B performs a humidification process for the sheet transferred from the image forming apparatus A connected at an upstream side thereof.

The sheet humidification apparatus B of the present invention is provided with a first mode where the sheet S is conveyed from the image forming apparatus A to the bookbinding apparatus C without being subject to processing and a second mode where the sheet is humidified and conveyed.

Also, the sheet humidification apparatus B is provided with a curling correction device to correct curing and undulation of the sheet S.

Selection of the above modes and selection of whether or not curling correction is carried out according to instruction operation at an operation display section 91 of the image forming apparatus A, instruction operation at an operation display section 92 of the sheet humidification apparatus B or a command from external equipment via a network.

The bookbinding apparatus C is an apparatus to accumulate the sheets S sent from the sheet humidification apparatus B to form a sheet bundle and adhere a cover sheet onto the formed sheet bundle.

The bookbinding apparatus C of the present embodiment is configured with a sheet conveyance device 210, a sheet ejection device 220, a coversheet supplying device 230, a sheet bundle storage device 240, a sheet bundle conveyance device 250, a glue application device 260, a coversheet adhering device 270, a coversheet folding device 280 and a booklet ejection device 290.

As the figure shows, the above devices are disposed serially in a vertical direction in the apparatus.

When a mode in which the sheet S is not subject to the bookbinding process, is selected through the operation display section 91 of the image forming apparatus A, a conveyance path to the sheet bundle storage device 240 is closed and a conveyance path to the sheet ejection device 220 is opened.

When the bookbinding mode is set, the sheets S are consecutively stacked and stored at a predetermined position in the sheet bundle storage device 240 to be a sheet bundle configured with a predetermined number of sheets S.

The sheet bundle formed on the sheet bundle storage device 240 is sent to the sheet bundle holding device 250. The sheet bundle holding device 250 turns to be a vertical state. In this state, glue is applied to a bottom surface of the sheet bundle by the glue application device 260, and the sheet bundle is formed.

To the formed sheet bundle, a coversheet is supplied form the coversheet adhering device 270 and adhered onto the sheet bundle, then the coversheet is folded by the coversheet folding device 280 to be a booklet.

The formed booklet is ejected via the booklet ejection device 290 from the bookbinding apparatus C.

Meanwhile, the bookbinding apparatus is such an apparatus disclosed in unexamined Japanese patent application publication No. 2004-209869.

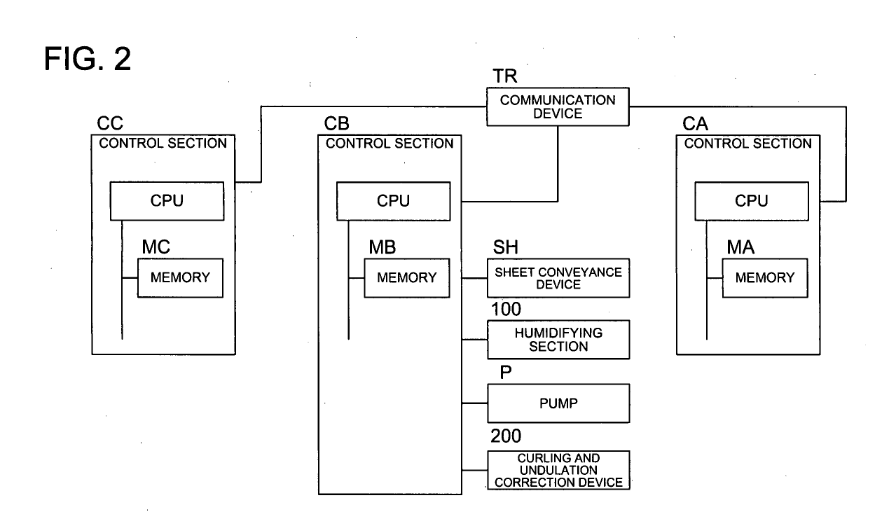

FIG. 2 is a block diagram showing a control system of the image forming system.

A control section CA of the image forming apparatus A, a control section CB of the sheet humidification apparatus B and a control section CC of the bookbinding apparatus C are computer systems having CPUs, memories, I/O ports, communication interfaces, drive circuitries and so forth.

The above control sections perform control by executing predetermined programs stored in the memories MA, MB and MC belonging to each apparatus.

Also, each of above control sections is connected via the communication device TR to exchange information.

Meanwhile, in the figure, blocks not related directly to description of the present invention are omitted.

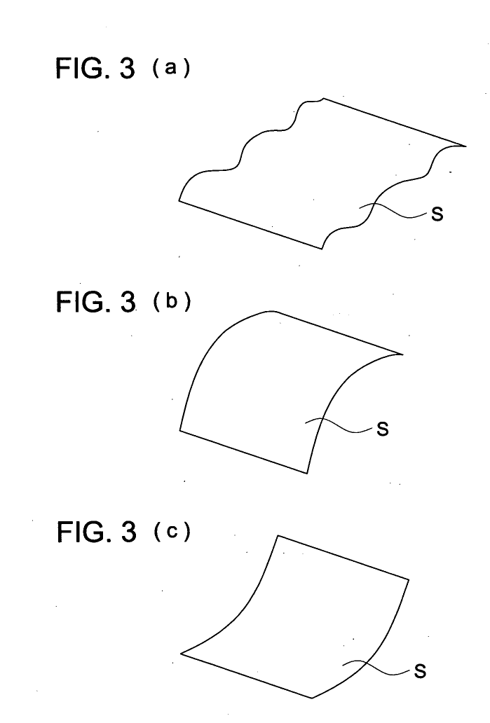

FIGS. 3(a), (b) and (c) are diagrams showing typical examples of undulation and curling generated on the sheet S sent from the image forming apparatus A.

FIG. 3(a) shows an example of undulation, FIG. 3(b) shows an example of curling which is convexed upward and FIG. 3(c) shows an example of curling which is concaved upward.

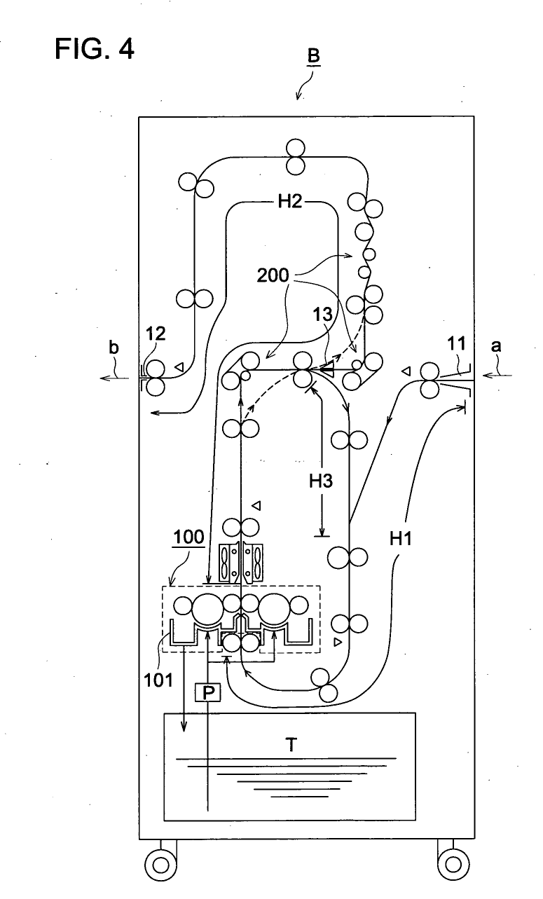

FIG. 4 is a conceptual diagram of a sheet humidification apparatus.

The sheet S sent form the image forming apparatus A enters to the sheet humidification apparatus B from an arrow a direction, and pursues in a sheet conveyance path H1 from an entrance port 11 to a humidification section 100, and in a sheet conveyance path H2 from the humidification section 100 to the sending out port 12, then sent to the bookbinding apparatus C in a direction of an arrow b.

The sheet S pursued in the sheet conveyance path H1 is subject to humidification processing by the humidification section 100.

Meanwhile, a conveyance path H3 is a conveyance path which returns the sheet S after humidification processing to the conveyance path H1 again form the conveyance path H2 by changing the conveyance path changeover guide 13 to change a course of the sheet S.

The sheet S returned to the sheet path H1 is again subject to the humidification processing.

In each of the above sheet conveyance paths, there are disposed a plurality of guide members (unillustrate) as sheet conveyance devices SH, conveyance path changeover guides, and conveyance rollers. The sheet S is led to as to pursue in the predetermined sheet conveyance path by the sheet conveyance devices SH.

Under the humidification section 100, a tank T to reserve water used for humidification is disposed.

Water reserved in the tank T is fed to the humidification section 100 by a pump P. Overflow is returned to the tank T for reuse.

Also, above the humidification section 100, an undulation and curling correction device 200 utilizing a publicly known technology to correct undulation and curling of the sheet S is disposed.

Selection of whether or not curling correction, or selection of nature of correction is carried out based on instruction operation at an operation display section 91 of the image forming apparatus A, an operation display section 92 of the sheet humidification apparatus A or a command from external equipment via a network.

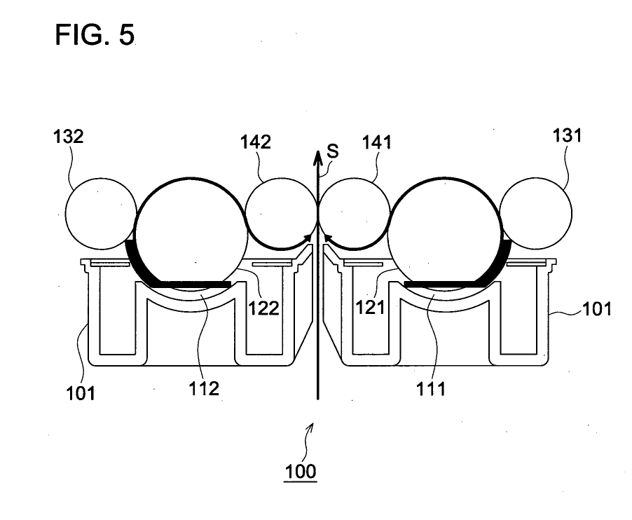

FIG. 5 is a conceptual diagram of a sheet humidification section.

The humidification section 100 is a device to apply water onto both surfaces of the sheet S being conveyed by two humidification rollers disposed opposite to each other.

As the figure shows, the humidification section 100 is configured with a plurality of members disposed bilaterally symmetrically centering around the conveyance path of the sheet S.

In the humidification section 100, there is disposed an application fluid reserving member 101 having application fluid trays 111 and 112 to reserve a certain amount of water representing the application fluid at an upper part thereof.

The application fluid trays 111 and 112 reversed a certain amount of water fed from the tank T by the pump P. The overflow from the trays flows out to a specific place of the application fluid reserving member 101.

The water flowed out is returned to the tank T for reuse as described in the forgoing.

Above the application fluid reserving member, there are disposed replenishing rollers 121 and 122 whose circumferential surfaces are partially immersed in the water in the application fluid trays 111 and 112.

To the replenishing rollers 121 and 122, control rollers 131 and 132, and humidification rollers 141 and 142 are in contact.

The replenishing rollers 1221 and 122 are rollers formed with solid rubber member having a hydrophilic property which rotate while a portion of the circumferential surface of the roller thereof is being immersed in the fluid in the application fluid trays 111 and 112.

Also, the control rollers 131 and 132 press the replenishing rollers 121 and 122 with a bias force having a predetermined value.

Meanwhile, a bias force changing device (unillustrated) is a publicly know mechanism supporting both axis ends of the control rollers 131 and 132, and biasing the control rollers 131 and 132 towards the replenishing rollers 121 and 122.

By providing such control rollers 131 and 132, control is carried out to change adhering amount of the water adhered on the circumferential surface of the replenishing rollers 121 and 122 by immersing.

The water on the replenishing rollers 121 and 122 is conveyed to the humidification rollers 141 and 142, and conveyed from the humidification rollers 141 and 142 to the sheet S.

Since the humidification rollers 141 and 142 are the application rollers having the same diameters disposed opposite to each other, it is easy to apply the water onto the both surfaces of the sheet S in the same amount. Thus the sheet S can be conveyed steady.

For the above rollers, for example, as the replenishing rollers, solid rubber rollers formed with NBR (nitrile butadiene rubber) with a hardness of 25 and a diameter of 35 mm, as the control rollers, metal rollers with a diameter of 22 mm, and as the humidification rollers, solid rubber rollers formed with NBR with a hardness of 25 and a diameter of 22 mm can be utilized.

As above, by utilizing the solid rubber rollers for the humidification rollers and the replenishing rollers, a high durability and a preferable water supply performance can be obtained. Also, by utilizing the metal rollers for the control rollers, control of the water adhering amount onto the replenishing rollers can be readily carried out.

As above, the humidification section 100 to humidify the sheet S by application method has been described. Next, effects of humidification by the humidification section 100 will be described.

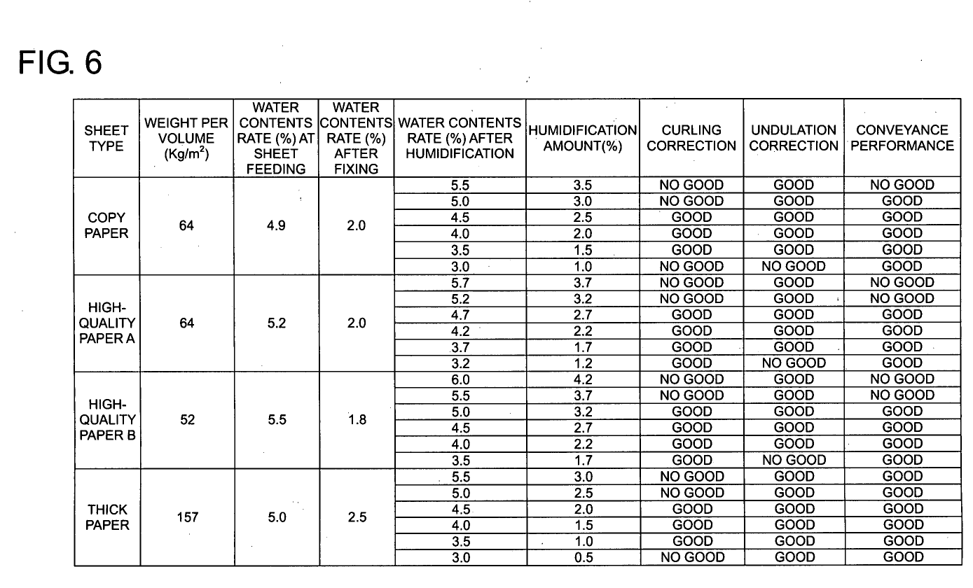

FIG. 6 is a diagram showing a relation between the humidification amount and humidification effect.

The figure is results of evaluation of curling correction, undulation correction and conveyance performance, which were obtained via the humidification process carried out on the sheet after fixing as the effect.

Four kinds of sheets were used for the experiment, which are a copying paper (weight per volume 64 g/m²): popularly used in a large amount, a high quality paper A (weight per volume 64 g/m²) used for offset printing in a large amount and again a high quality paper B (weight per volume 52 g/m²) used for offset printing and a thick paper (weight per volume 157 g/m²).

Percentages of water content of the four kinds of paper, namely the percentages of water content in the sheet feeding tray are in a rage of 4.9% to 5.5% and substantially 5%, and percentages of water content after fixing is from 4.8% to 2.5% which defers with weight per volume of the sheets S.

MX 5000™ of Shinmei General Co., Ltd. was used to measure the percentages of water content.

The result of evaluation reveals that the humidification is necessary in a range where the percentages of the water content after humidification do not exceed that of the sheet S before the fixing process.

Also, it is indicated that preferable effects were produced for all the sheets used in the experiment, when the humidification process was carried out so that the percentages of water content of the sheets S after the humidification process become lower than that before the fixing process by 0.5% to 1.5%.

Therefore, a preferable humidification process is that, for example, in case the percentage of water content of a copying paper before fixing process is 4.9% and reduced to 2% after the fixing process, the water content of the copying paper is increased to a range of 3.5% to 4.5%.

Also, in case of, the percentage of water contents the high quality paper A before fixing process is 5.2% and reduced to 2% after fixing process, the paper is humidified so that the percentage of water content falls within a rage of 3.7 to 4.7%.

The humidification amount is changed by changing the bias force of the control rollers 131 and 132 applied onto the replenishing rollers 121 and 122.

For example, as the bias force was changed to 750 g, 1500 g and 2500 g, increases of the percentage of water content of the sheet S were 3%, 2% and 1%.

Meanwhile, change of humidification amount can be carried out by changing a surface roughness of the replenishing rollers 121 and 122 and the humidification rollers 141 and 142 instead of changing the bias force of the control rollers 131 and 132 applied onto the replenishing rollers 121 and 122. Namely, the rollers can be replaced with rollers having different surface roughness.

As practical examples, as the surface roughness was changed to Rz 20 μm, Rz 14 μm, and Rz 7 μm, the increases of the percentage of water content changed to 3%, 2% and 1%.

Also, the humidification amount can be changed by changing number of passing times of the sheet S, where the sheet S passes through the humidification section 100 a plurality of times.

As an example, when the number of passing times was 1, 2 and 3 times, the corresponding increase of the percentage of water content were 1%, 2% and 3%

As above, numeric values related to the humidification amount, which are changed by, changing the bias force of the control rollers 131 and 132, by changing the surface roughness of the humidification rollers 141 and 142 or by changing the number of passing times through the humidification section 100 are obtained through experiments and determined when the apparatus is designed.

As described above, the sheet S sent form the image forming apparatus A is humidified by the sheet humidification apparatus B until a preferable percentage of water content is obtained.

As the result, there is realized an image forming system wherein undulation and curling of the sheet S are corrected, conveyance performance of sheet is enhanced and steady post-processing such as bookbinding can carried out.

Meanwhile, each apparatus configuring the image forming system can be connected as the present embodiment so that each apparatus operate as an image forming system to execute a predetermined process successively, or can be disconnected to be operated individually so that a predetermined process is executed in a batch processing mode.

What is claimed is:

1. A sheet humidification apparatus to performs a humidification process on a sheet conveyed from an image forming apparatus in which the sheet is fed from a sheet feeding tray one by one, a toner image is formed on the sheet and the formed toner image is fixed by heat on the sheet, comprising:
a humidification section to perform the humidification process so that a percentage of water content of the sheet after the humidification process does not exceed that of the sheet in the sheet feeding tray.

2. The sheet humidification apparatus of claim 1, wherein the humidification section includes:
two sets of humidification devices each having;
a humidification roller to humidify the sheet by applying water,
a water replenishing roller to replenish water to the humidification roller,
a control roller to press the water replenishing roller, and
a reservoir tray to reserve water to be replenished, wherein a portion of the water replenishing roller is immersed therein, wherein
the humidification rollers of two sets of the humidification devices are opposed to each other and the two sets of the humidification devices are disposed bilaterally symmetrically.

3. The sheet humidification apparatus of claim 2, wherein the humidification roller is formed with a hydrophilic solid robber.

4. The sheet humidification apparatus of claim 2, wherein a humidification amount is changed by changing a bias force of the control roller applied to the water replenishing roller.

5. The sheet humidification apparatus of claim 2, wherein a humidification amount is changed by changing a surface roughness of the humidification roller or the water replenishing roller.

6. The sheet humidification apparatus of claim 2, wherein a humidification amount is changed by changing number of passing times of the sheet to pass through the humidification section.

7. The sheet humidification apparatus of claim 1, wherein the humidification amount is controlled so that a percentage of water content of the sheet after a humidification process is lower than that of sheet in the sheet feeding tray by 0.5% to 1.5%.

8. An image forming system, wherein the sheet humidification apparatus of claim 1 is connected to an electrophotographic image forming apparatus.

9. The image forming system of claim 8, wherein a bookbinding apparatus to carry out a bookbinding process on the sheet is connected with the sheet humidification apparatus at a downstream side thereof in a sheet conveyance direction.
